(19) United States
(12) Patent Application Publication
(10) Pub. No.: US 2017/0132710 A1
(43) Pub. Date: May 11, 2017

(54) SYSTEM AND METHOD FOR MONITORING DRIVING TO DETERMINE AN INSURANCE PROPERTY

(71) Applicant: Elwha LLC, Bellevue, WA (US)

(72) Inventors: William David Duncan, Sammamish, WA (US); Roderick A. Hyde, Redmond, WA (US); Jordin T. Kare, San Jose, CA (US); Tony S. Pan, Bellevue, WA (US)

(73) Assignee: Elwha LLC

(21) Appl. No.: 15/223,684

(22) Filed: Jul. 29, 2016

Related U.S. Application Data
(63) Continuation of application No. 13/925,154, filed on Jun. 24, 2013, now abandoned.

(51) Int. Cl. G06Q 40/08; B60R 16/023; G07C 5/08; G07C 5/00

(52) U.S. Cl. CPC G06Q 40/08; G07C 5/008; B60R 16/0231; G07C 5/0841

(57) ABSTRACT

A method for determining a property of an insurance policy includes receiving sensor data from a portable electronic device regarding a driving event involving a first vehicle. The sensor data is provided by the portable electronic device in response to a user initiating a command to report the driving event. The portable electronic device is external to the first vehicle. The method includes identifying, based on the sensor data, one or more of the first vehicle and a driver of the first vehicle. The method includes determining risk data associated with one or more of the first vehicle and the driver based on the driving event. The method further includes automatically updating an insurance property of an insurance policy associated with one or more of the first vehicle and the driver based on the risk data.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

This application is a continuation of U.S. patent application Ser. No. 13/925,154 filed on Jun. 24, 2013, titled “System And Method For Monitoring Driving To Determine An Insurance Property,” which application is hereby incorporated by reference in its entirety, including the claims thereof.

### RELATED APPLICATIONS

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc., applications of the Priority Applications and the Related Applications, including any priority claims, is incorporated herein by reference to the extent such subject matter is not inconsistent herewith.

### TECHNICAL FIELD

This disclosure relates to vehicle monitoring systems.

### BRIEF DESCRIPTION OF THE FIGURES

FIG. 1 is a schematic block diagram illustrating one embodiment of a driving monitoring system.

FIG. 2 is a schematic block diagram illustrating one embodiment of a driving monitoring component.

FIG. 3 is a schematic block diagram illustrating one embodiment of a portable electronic device.

FIG. 4 is a front view of a vehicle illustrating an image captured by a camera.

FIG. 5 is a perspective view of a roadway illustrating an image captured by a camera.

FIG. 6 is a perspective view of an intersection illustrating an image captured by a camera.

FIG. 7 is a screen shot of an interface for obtaining sensor data of a driving event, according to one embodiment.

FIG. 8 is a screen shot of an interface for entering a description of a driving event, according to one embodiment.

FIG. 9 illustrates a flow chart of one embodiment of a method for determining a property of an insurance policy.

FIG. 10 illustrates a flow chart of one embodiment of a method for obtaining driving data for an insurance provider.

FIG. 11 illustrates a flow chart of one embodiment of a method for updating a property of an insurance policy.

FIG. 12 illustrates a flow chart of one embodiment of a method for reporting a driving event.

### DETAILED DESCRIPTION

Insurance coverage allows risk to be shared or transferred between individuals or entities. Insurance companies generally insure a large number of people, assets, or entities which allows them to use premiums paid from multiple parties to cover any payments required by the insurance coverage. Generally, a premium or a type of coverage that is available is based on a variety of factors which allows the insurance provider to group individuals, entities, or assets according to risk and provide coverage and/or insurance premiums accordingly. One example of a type of insurance includes a vehicle insurance policy.

Generally, vehicle insurance rates or coverage are based on a variety of factors including the cost of a vehicle, the type of vehicle, an age of an insured driver, a location where the vehicle is parked at night, and a variety of other factors. However, driving data indicating how a person actually drives, where a vehicle is driven, how far the vehicle is driven, or the like, can be difficult to obtain.

One way to determine how an individual actually drives, or how a vehicle is actually driven, is to require use of a tracking device in the vehicle. The tracking device may report how the vehicle is driven and the insurance provider can determine a more specific risk for that individual or vehicle. However, individuals may not properly use a tracking device and may be hesitant to install or use such a device within their vehicle. Thus, monitoring of the vehicle can be unpredictable and inaccurate and many individuals may actually forgo coverage under policies that require use of the tracking device.

Applicants have recognized that many individuals carry portable electronic devices which may be used to monitor and/or report the driving of others. People may have a desire to report other bad drivers simply to keep roads safer as well as to reduce the insurance costs to themselves. In effect, if others drive safely the reduced cost of insuring a group can reduce premiums for each insured individual or entity. Applicants have also recognized that monetary incentives can also encourage reporting of unsafe driving by others.

According to one embodiment, a driving monitoring system receives sensor data from a portable electronic device regarding a driving event involving a first vehicle. The sensor data is provided by the portable electronic device in response to a user initiating a command to report the driving event and the portable electronic device is external to the first vehicle. The system identifies, based on the sensor data, one or more of the first vehicle and a driver of the first vehicle and determines risk data associated with one or more of the first vehicle and the driver based on the driving event. The system automatically updates an insurance property of an insurance policy associated with one or more of the first vehicle and the driver based on the risk data.

As used herein, the term “insurance policy” is given to mean any risk-transference contract between an insurer and an insured (policy provider and policy holder) in which the insurer agrees to satisfy qualifying claims brought by the insured. An insurance policy may include, but is not limited to, one or more of: a vehicle insurance policy, a health insurance policy, a life insurance policy, a disability insurance policy, a workers' compensation insurance policy, a group insurance policy, or the like. The “insurer” may be any entity responsible for satisfying claims under the insurance policy, and may include an agent of the insurer (e.g., employee, independent contractor, or other authorized entity), an underwriter, a re-insurer, or the like. As used herein, an insurance policy may pertain to any asset or entity including, but not limited to: a vehicle, a fleet of vehicles, an operator of a vehicle, a passenger of a vehicle, an owner of a vehicle, an entity having a security interest in a vehicle, an entity having a relationship with an operator, a passenger, and/or an owner of the vehicle (e.g., an employer of the vehicle operator), and so on.

As used herein, a “property” of an insurance policy includes, but is not limited to, one or more of: a term of the insurance policy, eligibility for coverage under the insurance policy, a premium of the insurance policy, a coverage amount of the insurance policy, a deductible of the insurance policy, a rider of the insurance policy, a limitation of the insurance policy, a coverage scope of the insurance policy, the coverage of a particular event under the insurance policy, or the like. Although the specific example of insurance policies are disclosed herein, the disclosure is not limited in this regard and could be adapted to any suitable risk-transference and/or risk-mitigation mechanisms.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

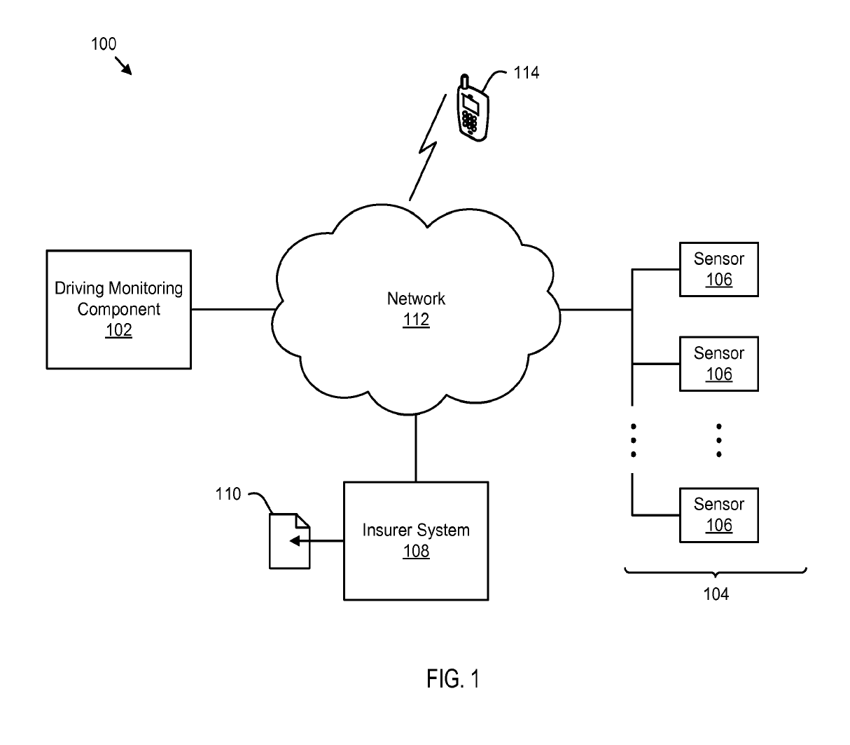

FIG. 1 is a schematic diagram illustrating a driving monitoring system 100 for monitoring driving and determining a property of an insurance policy. The system 100 includes a driving monitoring component 102, a traffic monitoring system 104 that includes one or more sensors 106, an insurer system 108 that determines a property of an insurance policy 110, a network 112, and a portable electronic device 114. Although the driving monitoring component 102, traffic monitoring systems 104, and insurer system 108 are shown as separate components or system, they may be combined into a single system and/or have a common operator, in some embodiments.

The driving monitoring component 102 receives data from the traffic monitoring system 104. The data may include sensor data obtained by the sensors 106 and/or may include driving data based on the data gathered by the sensors 106. In one embodiment, the driving monitoring component 102 receives data that may be used to identify a vehicle or person. The data may also include data regarding an event involving the vehicle.

The traffic monitoring system 104 may include traffic monitoring infrastructure that includes the sensors 106. The traffic monitoring system 104 may be a system that is owned and/or operated by one or more insurance entities. For example, the traffic monitoring system 104 may be owned and/or operated by a single insurance provider to monitor traffic and determine insurance properties. As another example, the traffic monitoring system 104 may be owned and/or operated as part of a driving data clearinghouse so that the cost of ownership and operation can be shared by multiple insurance companies or entities. In one embodiment, the traffic monitoring system 104 is a publicly owned traffic monitoring system. For example, the traffic monitoring system 104 may include traffic cameras, speeding cameras, radar units, or other sensors or devices used by a government entity to monitor traffic and/or issue citations for traffic violations. In one embodiment, a government entity may charge for access to data provided by the traffic monitoring system 104 to reduce the burden of installing or operating the traffic monitoring system 104.

The traffic monitoring system 104 may include a number of sensors 106 positioned to observe vehicles, weather conditions, and/or traffic conditions. The sensors 106 may include sensors positioned to observe a roadway, an intersection with a traffic signal, an intersection with a traffic sign, a bridge, a toll lane, and/or a high-occupancy vehicle (HOV) lane. The sensors 106 may be mounted at a fixed position such as on a building, post, traffic signal, or the like. A sensor 106 may also be mounted on an aircraft. Examples of sensors 106 of the traffic monitoring system 104 include, but are not limited to, cameras, radar units, identification tag readers, temperature sensors, wind sensors, proximity sensors, and the like. In one embodiment, a camera may include a video camera, still camera, road conditions camera, weather camera, security camera, stereoscopic camera, three-dimensional imaging camera, infrared camera, night vision imager, or the like. In one embodiment, a camera may also include or have a corresponding illumination source. In one embodiment, an identification tag reader may be configured to read machine readable codes, radio frequency identification (RFID) tags, or other tags on a vehicle. The identification tag reader may be configured to read a wireless identification signal transmitted from a vehicle and/or a driver of the vehicle. The traffic monitoring system 104 may include a microphone for obtaining audio data and/or a clock for determining a time at which an event occurs.

The driving data provided by the traffic monitoring system 104 may include unprocessed or processed sensor data. For example, the traffic monitoring system 104 may simply forward video captured by a camera without detecting vehicles in the video or performing other visual processing. In another embodiment, the traffic monitoring system 104 may process the video to identify vehicles, determine speed or violations, and/or determine other information from the video. The traffic monitoring system 104 may then forward the sensor data and/or data related to processing the sensor data to the driving monitoring component 102 as driving data.

In one embodiment, the driving monitoring component 102 determines risk data for the vehicle or driver based on the driving data. For example, the driving monitoring component 102 may calculate a risk score based on the driving data and/or other data on the vehicle or driver. The driving monitoring component 102 may then forward the risk score and/or other data to the insurer system 108. The insurer system 108 may receive the risk data from the driving monitoring component 102 and determine a property of the insurance policy 110. For example, the insurer system may automatically determine a rate, coverage, or other insurance property based on the risk data.

In one embodiment, the insurer system 108 and/or the driving monitoring component 102 may be part of the same system and/or operated/owned by the same entity. For example, in one embodiment the driving monitoring component 102 may function as a clearing house for sensor and other driving data and forward risk data to other entities, such as insurance companies, for determination of insurance properties. In another embodiment, the driving monitoring component 102 and the insurer system 108 may be owned and/or operated by the same entity, such as an insurance provider. Thus there may be no need to forward data to another entity for processing or for determining an insurance property.

In one embodiment, the driving monitoring component 102 and/or traffic monitoring system 104 may operate as a clearing house entity that receives sensor data and stores and/or processes the sensor data for one or more destination insurance entities, or the like. For example, the driving monitoring component 102 and/or the traffic monitoring system 104 may obtain or receive the sensor data and simply store the data for access by an insurance provider or other insurance entity. As another example, the driving monitoring component 102 may perform enough processing to determine an entity or location to which the sensor data should be provided. As yet another example, the driving monitoring component 102 may process the sensor data to identify events or people, or perform other processing prior to providing the sensor data and/or other data to an insurance entity or system.

The portable electronic device 114 may be configured to allow a user to report on the driving of another vehicle or driver. For example, the portable electronic device 114 may allow a user to initiate reporting of a traffic incident or other incident involving a nearby vehicle. The portable electronic device 114 may forward sensor data captured by the portable electronic device as part of the report. The portable electronic device 114 may include any type of mobile computing or communication device such as a mobile phone, a tablet computer, a camera, or the like. In one embodiment, the portable electronic device 114 includes a reporting application installed on a smart phone. Thus, users in another vehicle may record a video or image of a nearby vehicle for reporting of the vehicle. The portable electronic device 114 may also include a dash camera or rear view camera of a vehicle which may be used to record events surrounding the vehicle which may be used to report occurrence of an event. Similarly, a pedestrian may obtain sensor data using a portable electronic device 114 and then report an incident using the data. The driving monitoring component 102 may receive sensor data and/or reports sent by the portable electronic device 114.

The network 112 allows for communication between the driving monitoring component 102, traffic monitoring system 104, the insurer system 108 and/or the portable electronic device 114. The network 112 may include one or more networks including secured or openly accessible networks such as a local area network (LAN), a wide area network (WAN), the Internet, or the like.

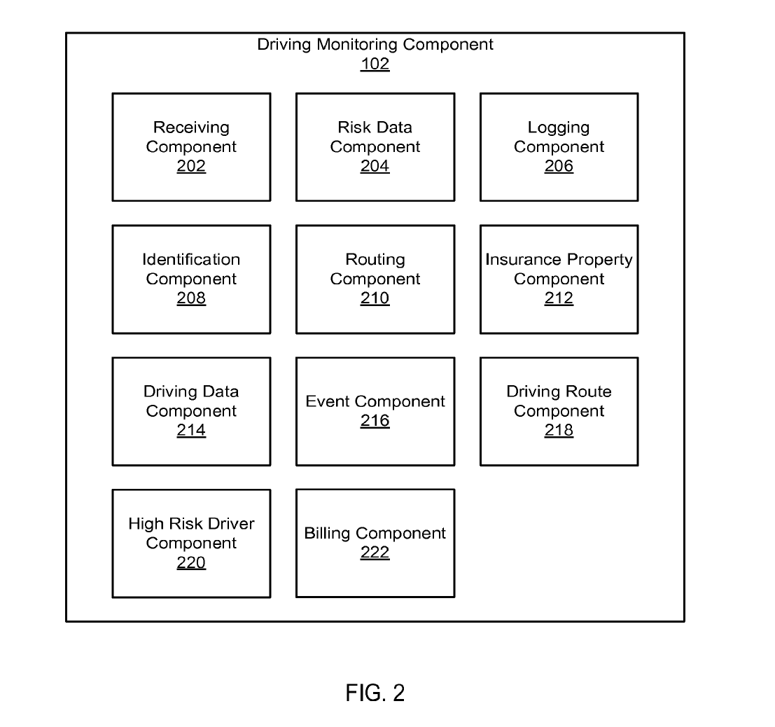

FIG. 2 is a schematic block diagram illustrating example components of the driving monitoring component 102 of FIG. 1. The driving monitoring component 102 includes a receiving component 202, a risk data component 204, a logging component 206, an identification component 208, a routing component 210, an insurance property component 212, a driving data component 214, an event component 216, a driving route component 218, a high risk driver component 220, and a billing component 222. The components 202-222 are given by way of example only and may not all be included in some embodiments. In fact, some embodiments may include only one or any combination of two or more of the components 202-222.

The receiving component 202 receives driving data for a vehicle. The receiving component 202 may receive the driving data from a traffic monitoring system 104, portable electronic device 114, or other system or device. For example, driving data based on sensor data gathered by the sensors 106 of FIG. 1 may be sent by the traffic monitoring system 104 and received by the receiving component 202. Similarly, a user may initiate sending of a report including sensor data and/or driving data for a nearby vehicle from a portable electronic device 114.

In one embodiment, the receiving component 202 is configured to receive the driving data in real-time. In one embodiment, the receiving component 202 may receive the driving data in real-time by receiving a sensor data feed from one or more sensors. For example, the traffic monitoring system 104 may be configured to provide driving data within a required real-time threshold or the receiving component 202 may be configured to periodically check for and receive data within a required time period. In another embodiment, periodic reports that include driving data may be received by the receiving component 202. For example, each report may include all driving data for a vehicle that has been obtained or generated during a reporting period. Similarly, driving data or sensor data received from a portable electronic device may be received, processed, and/or forwarded in real-time.

According to one embodiment, the receiving component 202 receives driving data that includes sensor data. For example, the driving data may include visual data such as an image or video of the vehicle or driver. The driving data may include location data such as global positioning system (GPS) data, a location of a portable electronic device 114, a location based on signaling between a portable electronic device 114 and a mobile network, or the like. In one embodiment, the location data includes a map coordinate, includes a road name, and/or indicates a traffic lane in which the vehicle was located. The location data may include information about a path travelled by the vehicle. The driving data may include audio, time information, acceleration rate information, or other information about the vehicle.

In one embodiment, the driving data includes velocity data, such as a velocity obtained by a radar unit. The velocity data may be obtained based on differential location and time data. For example, the position of the vehicle at two different points in time may be compared to determine a velocity travelled during the intervening time period. In one embodiment, the velocity data includes direction of travel data that indicates a direction of travel of the vehicle. In one embodiment, the driving data includes an angular orientation of the vehicle, an angular velocity of the vehicle, and/or an angular acceleration of the vehicle.

According to one embodiment, the driving data includes data about a driving event in which the vehicle was involved. For example, the driving data may include a description, video footage, images, or other sensor data regarding a driving event. In one embodiment, the driving data and/or sensor data may be used to detect, reconstruct, or prove the occurrence of the driving event. For example, the driving data may include sensor data that provides evidence of the occurrence of the driving event or of the vehicle being involved with the driving event.

In one embodiment, the driving data includes evidence of the presence of a vehicle or driver at a specific location. For example, an image or a reading of an identification tag may provide evidence that the vehicle or driver was at the location of a sensor or near a portable electronic device 114 that obtained the data. The driving data may also include sensor data corresponding to the vehicle during an occurrence of the driving event. For example, the driving data may include video that illustrates a vehicle passing through an intersection during a red light. In one embodiment, identification data, such as license plate data, or other data may provide evidence that a vehicle or driver was at a specific location or involved in a specific driving event.

The driving data may include information about an occurrence of various types of driving events including an unsafe lane change by the vehicle, the vehicle exceeding a speed limit, the vehicle violating a traffic signal, the vehicle passing through a cross-walk occupied by a pedestrian, the vehicle accelerating at an excessive rate, impact between the vehicle and an object, person, or animal, the vehicle following another vehicle too closely (also known as tailgating), the driver drinking while driving, the driver eating while driving, the driver using a phone while driving, the driver performing an unsafe turn, or other driving event. In one embodiment, the driving events include events that affect a risk of insuring the individual. For example, speeding increases a risk of an accident and increases a likely amount of damage caused in an accident. Driving events may indicate increased risk of insuring, reduced risk of insuring, or both.

In one embodiment, the driving data includes information regarding roadway conditions such as a location of the vehicle in a construction zone, a weather condition, a wet road, an icy road, low visibility, or the like. The driving data may include information regarding traffic conditions, such as traffic volume, traffic speed, time of day, or the like. The driving data may include information regarding a driving route of the vehicle. For example, the driving route may be based on a number of locations where the vehicle has been detected. The information regarding the driving route may also include a type of roadway, or neighborhood through which the vehicle has been driven. The roadway types and neighborhoods may indicate how dangerous a route is that is travelled by the vehicle. For example, some roadways, roadway types, intersections, and/or neighborhoods may have a much larger incident of accidents, crime, or the like that increase the risk of insuring the vehicle, the driver, or a passenger.

In one embodiment, the driving data includes a description of a driving event, a roadway condition, traffic condition, a driving route, or the like as well as sensor data that provides evidence of the location of the vehicle or involvement of the vehicle in a driving event. For example, the evidence may include sensor data such as an image, video, velocity data, acceleration data, and/or the like during the occurrence of the driving event. Similarly, the driving data may include sensor data at a location near the driving event.

According to one embodiment, the driving data includes identification data for the vehicle and/or driver. The identification data may include data that can be used to identify the vehicle and/or driver. In one embodiment, the identification data may include an image or video of the vehicle, a license plate of the vehicle, and/or the driver of the vehicle. In one embodiment, the identification data includes an identifier value such as a value read from the license plate, machine readable tag, or RFID tag on the vehicle.

According to one embodiment, the receiving component 202 receives driving data from more than one sensor or device. In one embodiment, the receiving component 202 receives driving data based on sensor data from two different sensors, such as two different cameras. In one embodiment, the receiving component 202 receives a report from more than one portable electronic device 114. Data from multiple sensors and/or devices may allow for more exact detection of an event and/or stronger or additional evidence of a driving event.

The risk data component 204 determines risk data for a vehicle or driver based on the driving data. The risk data may indicate a risk of insuring the vehicle or a risk for specific activities, for specific types of coverage, or the like. Alternatively, the risk data may indicate a general risk level for the insurance type, such as for vehicle insurance, life insurance, etc. The risk data component 204 may determine the risk data by searching or querying driving data for data corresponding to a specific vehicle or driver. For example, the risk data component 204 may search through historical driving data, such as a driving log, to locate events or other information corresponding to a vehicle or driver. In one embodiment, the risk data component 204 may receive risk data corresponding to a specific vehicle and/or driver and determine corresponding risk data.

In one embodiment, the risk data component 204 determines risk data comprising a risk score. The risk score may include a value that indicates a level of risk for the vehicle or driver based on the risk data. The risk score may be a numerical or other indicator or value that facilitates grouping of individuals, assets, or entities. For example, individuals with the same score or scores within the same range may be grouped together as to available coverage, premium amounts, etc.

The risk data component 204 may determine the risk score based on one or more of a driving event, a roadway condition, a driving route, and/or a traffic condition reflected by the driving data and/or sensor data. For example, a driving event, a roadway condition, a driving route, and/or a traffic condition that indicates greater risk may result in the risk data component 204 determining a risk score indicating greater risk. Similarly, the risk data component 204 may determine a higher risk score in response to a greater number of driving events, roadway conditions, driving routes, and/or traffic conditions that indicate greater risk.

According to one embodiment, the risk data component 204 determines the risk score or risk data based on a log corresponding to the vehicle or individual. The logging component 206 logs driving data, such as data received by the receiving component 202, in a log corresponding to an individual, vehicle, or entity. For example, the logging component 206 may add a driving event, road condition, traffic condition, weather condition, driving route, or the like to a driving log. The driving log may allow tracking of the driving of an individual and vehicle so that general trends, habits, or other information about an individual driver or vehicle can be understood.

According to one embodiment, the logging component 206 may log driving data for each vehicle, person, or entity for which it receives data. In another embodiment, the logging component 206 may only log driving data for vehicles, persons, or entities that have a corresponding insurance policy that depends on tracked data. For example, vehicles or individuals who are not insured by a company that adjusts insurance properties based on driving data may not have a corresponding log. In one embodiment, logging data for each driver and/or individual may allow an insurance provider to evaluate driving data for a person who is applying for insurance coverage.

In one embodiment, the risk data component 204 determines risk data, such as a risk score based on driving data in a driving log. For example, the risk data component 204 may determine risk data based on all data within the driving log. For example, the risk data component 204 may determine a risk score based on a number of driving events, a risky driving event, a number of poor roadway conditions, a number of poor traffic conditions, a common risky driving route, or the like in the driving log. By using the driving log an understanding of the driving habits of the insured can be obtained and thus risk can be more accurately understood and accounted for in coverage and insurance costs.

The risk data may also indicate increased risk or decreased risk based on the amount of data in the log. For example, if a vehicle is speeding a majority of the times that the vehicle is detected, the risk data component 204 may determine a higher score than if the vehicle is caught speeding only once. Similarly, as more driving data is gathered, the less a single event, report, or the like may affect a risk score.

The risk data component 204 may determine risk data periodically so that insurance premiums, insurance coverage, or other insurance property can be periodically adjusted. For example, the risk data component 204 may determine a new risk score every month, year or other time period. In one embodiment, shorter periods may also be used such as periods of a day, an hour, or even a minute or less. In one embodiment, the risk data component 204 may update the risk data in real-time such that an insurance property can be updated in real-time. For example, each time driving data is received the risk data component 204 may calculate a new risk score within a real-time threshold.

The identification component 208 identifies an individual, vehicle, entity, or insurance policy based on the driving data. The identification component 208 may identify a vehicle based on a license plate of the vehicle and/or based on a tag on the vehicle. The identification component 208 may identify the vehicle based on a color of the vehicle, a make and model of the vehicle, a size and/or shape of the vehicle, or the like. The identification component 208 may identify a person, such as a driver, using facial recognition or based on a physical dimension or feature of the person. For example, an image of the person may be used to match the driver with a known person. For example, an image of the driver may be compared to images of drivers anticipated to have access to an identified vehicle, such as the owner, his family members, coworkers, or the like.

According to one embodiment, the identification component 208 determines an insurance policy or insurance provider that corresponds to an identified individual or vehicle. For example, the identification component 208 may access a database of insurance policies or companies with corresponding vehicles or drivers. The identification component 208 may determine that the insurance policy or provider corresponds to a vehicle or driver listed in the database.

In one embodiment, the identification component 208 determines whether the driver or vehicle is identifiable based on the driving data. In one embodiment, the identification component 208 may determine whether the driver or vehicle are identifiable based on sensor data. For example, in the case of a report from a portable electronic device 114, sensor data may be more difficult to falsify than text or a description entered by a user and thus may be used for more accurate identification of a person or vehicle. In one embodiment, the identification component 208 may determine whether the driving data includes an image of a vehicle, a license plate of a vehicle, a face of an individual, or other image for identifying a vehicle or individual. In one embodiment, if a report from a portable electronic device 114 does not include sensor data to reliably identify a vehicle and/or driver, the driving monitoring component 102 may reject the report and/or the data.

FIG. 4 illustrates an example image 400 of a vehicle 402. A driver 404 is visible in the vehicle 402 and a license plate 406 is visible on the front of the vehicle 402. The image 400 may be an image captured by a camera sensor 106 or portable electronic device 114 and provided to the driving monitoring component 102 as a portion of driving data. In one embodiment, the identification component 208 may determine whether a driver 404 or vehicle 702 is identifiable based on the image 400. For example, the identification component 208 may use object recognition, character recognition, and/or facial recognition to determine whether one of the driver 404 and vehicle 402 are identifiable. According to one embodiment, the identification component 208 detects the vehicle 402, driver 404, and license plate 406 in the image 400 and determines that the driver 404 and/or vehicle 402 are identifiable.

In one embodiment, the driving monitoring component 102 rejects driving data in response to the identification component 208 determining that the vehicle or the driver are not identifiable based on the driving data. The driving data and/or report may be discarded, flagged for review, and/or flagged as invalid. Rejecting driving data that does not include data to identify an individual or vehicle may reduce false reports or otherwise incorrect information being logged to an individual or vehicle. Similarly, other methods or functions may only be performed in response to determining that the vehicle and/or driver are identifiable based on the driving data or sensor data.

According to one embodiment, the identification component 208 identifies a source of the driving data, sensor data, or other data. For example, if sensor data is received from a portable electronic device 114, the identification component 208 may identify an owner or operator of the portable electronic device. Similarly, the identification component 208 may identify the portable electronic device 114. For example, the identification component 208 may log an internet protocol (IP) address, hardware identifier, or other identifier of the portable electronic device 114.

The routing component 210 provides driving data and/or risk data to an insurance provider. According to one embodiment, the routing component 210 provides the driving data or risk data to an insurance provider determined by the identification component 208. The routing component 210 may provide the driving data and/or risk data by sending a message that includes the data or a portion of the data to an insurer system 108. For example, the routing component 210 may notify an insurer that data is available about a policy member and the insurance provider may or may not request additional information. The message may or may not indicate an identity of the policy member. In one embodiment, the routing component 210 provides the driving data and/or risk data to the insurance provider by updating a database accessible by the insurance provider. For example, the insurer system 108 may be able to access the database to obtain the driving data and/or risk data. The routing component 210 may store the driving data and/or risk data so that the insurance provider or other insurance entity can access the data.

The routing component 210 may provide the data to the insurance provider on a periodic basis or in real-time. For example, the routing component 210 may provide the driving data and/or risk data to the insurance provider within a real-time interval of the receiving component 202 receiving the driving data, the driving data component 214 generating the driving data, and/or the risk data component 204 determining risk data. In one embodiment, the insurance provider may determine an insurance property based on the risk data and/or the driving data.

According to one embodiment, the routing component 210 may provide the data to other entities such as a legal authority. For example, the event component 216 may determine that the driving event potentially also constitutes a crime. In one embodiment, the event component may notify the routing component 210 or other component that a crime was detected. The legal authority may then be able to review the driving data and/or sensor data to determine whether legal action should be taken.

In one embodiment, the driving monitoring component 102 may include an insurance property component 212 that determines an insurance property based on risk data and/or driving data. According to one embodiment, the insurer system 108 of FIG. 1 may include an insurance property component 212. For example, if a driving monitoring component 102 functions as a clearing house, actual determination of insurance properties may be left to an insurance provider that corresponds to a driver or vehicle.

The insurance property component 212 automatically determines a property of an insurance policy based on the risk data. The insurance property component 212 may determine an insurance property such as a coverage scope, a premium amount, a coverage amount, a deductible, or other property of the insurance policy. In one embodiment, the insurance property component 212 determines an insurance property that defines coverage of an insurance policy. For example, the property may define coverage that at least complies with minimum insurance coverage required by law or defines coverage based on how much a vehicle is driven.

In one embodiment, the insurance property component 212 determines an insurance property based on a risk score for an individual, vehicle, or entity. In one embodiment, the insurance property component 212 determines an insurance property that reduces liability for the insurer in response to a higher risk score. For example, the insurance property component 212 may determine a property that reduces coverage scope or a coverage amount, or other property that reduces liability for the insurer. Similarly, the insurance property component 212 may determine an increase in the liability to an insurance owner, such as an individual or entity. For example, the insurance property component 212 may determine a property that increases a premium amount to be paid by the individual. The insurance property component 212 may also increase a coverage scope or decrease a premium amount in response to a lower risk score.

The insurance property component 212 may determine an insurance property or update an insurance property periodically or in real-time. For example, the insurance property component 212 may determine an insurance property periodically every minute, hour, day, month, year, or any other time period. Similarly, the insurance property component 212 may determine the insurance property in real-time. For example, the insurance property component 212 may determine an insurance property within a real-time update limit from receiving driving data and/or sensor data. The real-time update limit may include a time limit of one minute or less, one hour or less, or another time length.

The driving data component 214 generates driving data based on sensor data. As discussed elsewhere herein, a traffic monitoring system 104, portable electronic device 114, or other device may provide driving data to the driving monitoring component 102. In such a case, the driving data component 214 may not be needed or may be used to confirm that driving data provided by a traffic monitoring system 104, portable electronic device 114, or user is accurate or to generate additional driving data that was not received.

In one embodiment, the driving data component 214 generates driving data that includes a description of a driving event, traffic condition, driving route, weather condition, road condition, or the like that is interpretable by a human, insurer system 108, and/or another component of the driving monitoring component 102. The driving data component 214 may generate driving data based on events or routes detected by an event component 216 and/or a driving route component 218.

According to one embodiment, the driving data component 214 processes the sensor data to identify locations, velocities, and/or other data about a vehicle and/or surrounding objects. In one embodiment, the driving data component 214 processes visual data of one or more stationary objects to determine their locations. For example, the driving data component 214 may identify an object using an image recognition map and identify a position of the stationary objects from a map or database, or with respect to each other and/or with respect to a vehicle. In one embodiment, a location or position of the vehicle and/or objects may be determined based on a known location and/or orientation of a sensor. For example, a traffic camera may have a predetermined orientation and/or position so that all detected objects and vehicles can be located based on the known location and orientation of the traffic camera.

With regard to sensor data from a portable electronic device 114, a sensor may not have a predefined location and orientation. In one embodiment, the driving data component 214 may determine a direction of a camera in relation to one or more stationary objects visible in an image obtained by the camera. The direction of the camera may be determined based on an accelerometer or other sensor of a portable electronic device 114 that indicates an orientation of the camera. Additionally or alternatively, the direction of the camera may be determined based on stationary objects within an image that have a known location. For example, a pole, lane marker, or other object or marker can provide a reference point to determine an orientation, position, and/or direction of a camera.

The driving data component 214 may determine a direction of the camera in relation to a vehicle. For example, a camera picture may show an angular offset of the vehicle in relation to the camera and/or a stationary object. In one embodiment, a position of the vehicle may be determined using parallax and two images of the vehicle. For example, if two images of the same vehicle are obtained from different locations at the same time, parallax may be used to triangulate the position of the vehicle. Similarly, if the vehicle is stationary and an observer is moving, the position of the vehicle can likewise be determined. A location of a vehicle or object may also be determined based on the direction and range to a vehicle or object. Similarly, information about a lane in which a vehicle is compared to a location of a camera or a stationary object can provide information about the location of a vehicle.

The driving data component 214 may determine orientation, velocity, direction of travel, a traffic lane, and/or a road where the vehicle is located. This information may be based on a location and orientation of a sensor or as compared to one or more stationary objects. In one embodiment, the driving data component 214 may generate velocity data based on a position of the vehicle at a first time and a position at a second time. A velocity of a portable electronic device 114 may be used, in combination with sensor data, to determine a velocity, orientation, direction of travel, etc. of a vehicle. For example, a velocity of the portable electronic device 114 can be derived by integrating acceleration data from an accelerometer of the portable electronic device 114 to determine a velocity. Similarly, velocity of the portable electronic device 114 may be determined based on GPS, advanced GPS, or differential location data.

The event component 216 may detect events based on sensor data. The event component 216 may process video, images, audio, radar, accelerometer, temperature, time, or other sensor data to detect a variety of events. In one embodiment, the event component 216 detects driving events such as speeding, violating a traffic signal, following another vehicle too closely, performing excessive lane changes, changing lanes too close to another vehicle, or any other event. For example, the event component 216 may determine a speed of a vehicle, a proximity between a vehicle and other vehicles, individuals, or objects, movements or activities of a driver, or other information regarding the driving of a vehicle. Using this information, the event component 216 may then determine whether a driving event or other event has occurred. For example, the event component 216 may detect the occurrence of a first vehicle following a second vehicle too closely based on determining that the first vehicle is within a threshold distance of the second vehicle while both vehicles are moving. The threshold distance may vary based on the speed of one or both of the vehicles.

The event component 216 may track a position of a vehicle, people, and/or stationary objects and detect events based on their relative positions, movements, and the like. In one embodiment, the event component 216 detects the occurrence of events based on positions of a vehicle, a portable electronic device, and/or other objects, as tracked by the driving data component 214. For example, relative speed, proximity, or other information may be determined and used to detect whether a specific event has occurred.

The driving route component 218 determines a driving route of a vehicle based on the sensor data and/or the driving data. In one embodiment, the driving route component 218 generates a route of a vehicle based on the location at which a vehicle and/or driver are detected. For example, if the vehicle is detected at a first location and then detected at a second location within a defined time period, the driving route component 218 may generate a probable route followed by the vehicle to travel between the locations. Similarly, the driving route component 218 may utilize home address, work address, and/or other information to determine routes, distances, and the like of a driving route.

The driving route component 218 may generate a driving route that includes two or more locations at which the vehicle has been detected as well as information regarding the roadways, intersections, and/or neighborhoods where a vehicle has travelled. Some road, intersections, and/or neighborhoods may have increased or reduced chances of accidents, crimes, or other events that may be of interest to an insurer. The driving route component 218 may also estimate an amount of miles driven by the vehicle in a day, week, month, or other time period.

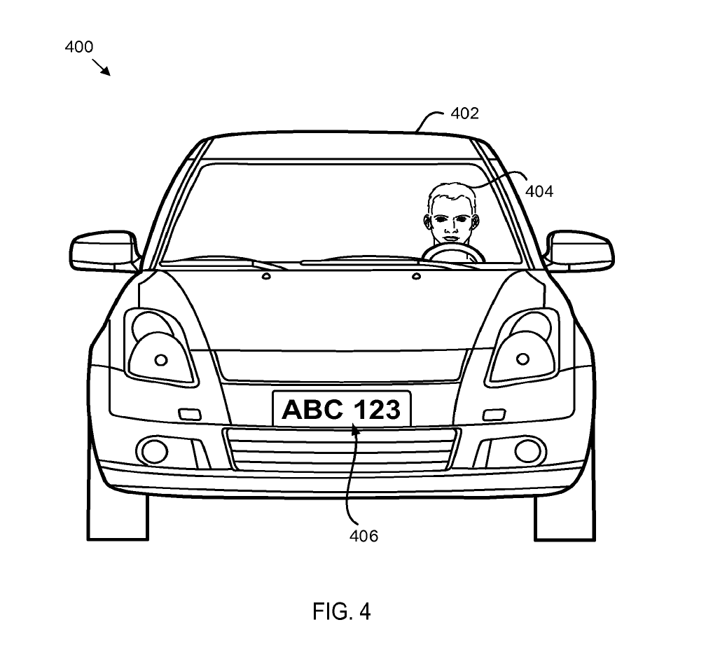

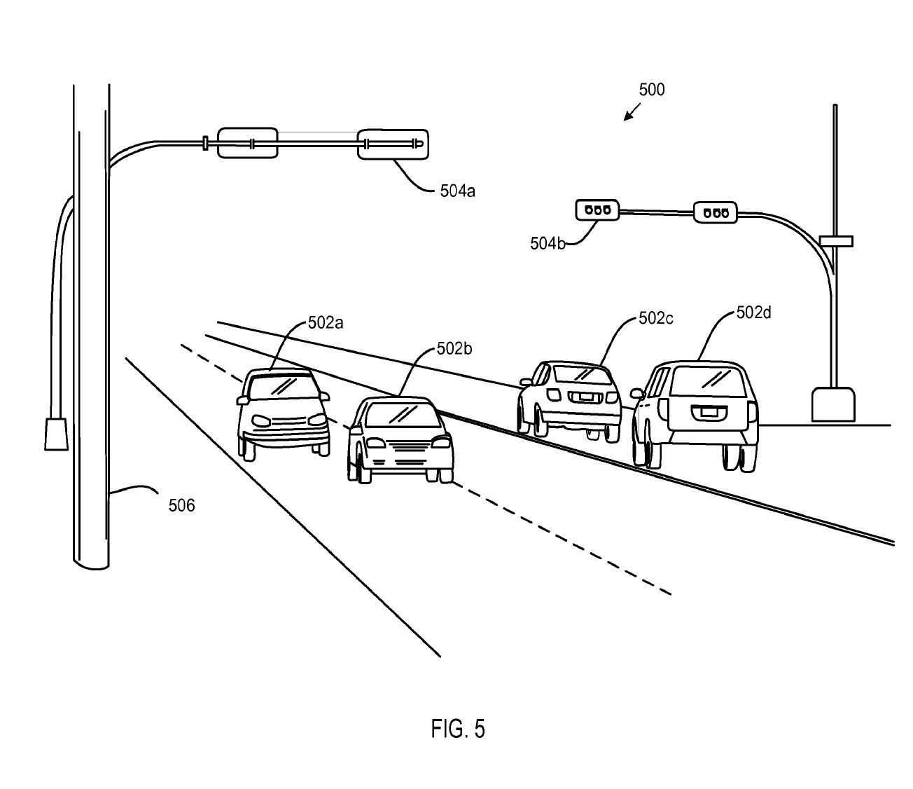

FIG. 5 illustrates an image of a roadway 500 that may be obtained by a camera, such as a traffic camera or a camera on a portable electronic device 114. The image depicts vehicles 502a, 502b, 502c, and 502d driving on the roadway 500. Traffic signals 504a and 504b may be used to control traffic through an intersection. A lamp post 506 may be used as a reference location to determine locations of passing vehicles. According to one embodiment, the image is a single image from a video feed provided by a video camera. The image and/or video feed may allow the driving monitoring component 102 to monitor driving of the vehicles 502a, 502b, 502c, and 502d as they drive down the roadway 500.

The driving data component 214 may determine driving data, based on the image, for one or more of the vehicles 502a, 502b, 502c, and 502d. For example, the driving data component 214 may generate driving data that indicates a location of a vehicle with respect to other vehicles, traffic lanes, or the like. The event component 216 may detect the occurrence of a driving event. For example, the event component 216 may detect the vehicle 502b changing lanes too closely to the vehicle 502a. The vehicle 502b is shown over a lane marker and in proximity to the vehicle 502a. In one embodiment, the driving data component 214 determines speeds and locations of the two vehicles 502a and 502b. If the vehicles pass too closely to each other for the speed they are driving, the event component 216 may determine that the vehicle 502b has changed lanes too closely to the vehicle 502a. The event may be logged by the logging component 206 in a log corresponding to the vehicle 502b. Similarly, the driving data component 214 and/or event component 216 may determine whether a vehicle is speeding, has violated a traffic signal 504a, 504b, or the like.

The driving route component 218 may determine a location of each of the vehicles 502a, 502b, 502c, and 502d for purposes of determining an overall driving route. For example, the driving route component 218 may combine data regarding a previous or subsequent location of the vehicle 502b to determine a driving route. The driving route may indicate which roads are travelled, which intersections are driven through, and/or the like to determine where the vehicle 502b was driven. This information may then be logged for evaluation of risk along the driving route. The driving route or direction of travel (projected forward or backward in time) may be used to indicate which sensor or sensors may be anticipated to provide additional information about a vehicle involved in a driving event or driven by a high risk driver. Data from such sensors can then be accessed at times based on that of the driving event.

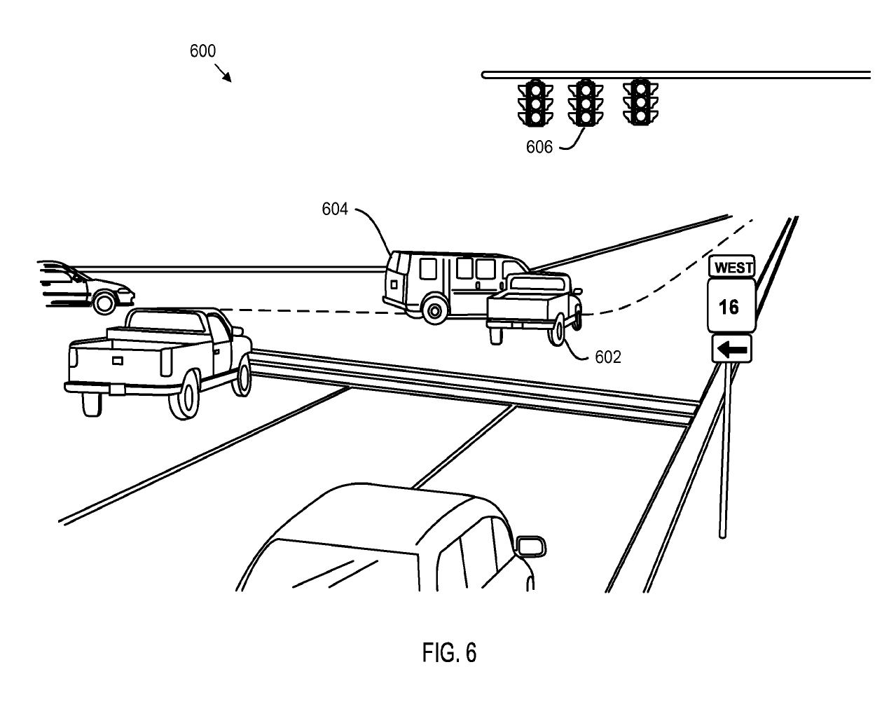

FIG. 6 is an image of an intersection 600 that may be obtained by a traffic signal camera. According to one embodiment, the traffic signal 606 indicates that the vehicle 602 should be stopped at the traffic signal to stay out of the intersection 600. A collision or near collision between the vehicle 602 and another vehicle 604 may also be detected. According to one embodiment, the driving data component 214 may detect the state of the traffic signal 606 and/or the positions of the vehicles 604 and 602. The event component 216 may detect violation of the signal by the vehicle 602 and the near collision with the vehicle 604. According to one embodiment, the event component 216 may forward the event data and/or driving data to the logging component 206 for logging and/or to the risk data component 204 for generation of risk data.

Returning to FIG. 2, the high risk driver component 220 determines whether a driver or vehicle corresponds to a high risk driver. In one embodiment, the high risk driver component 220 determines whether a driver or vehicle corresponds to a high risk driver based on an identity of the driver or vehicle as determined by the identification component 208. For example, the high risk driver component 220 may look up the driver or vehicle in a database to determine if the vehicle is a high risk driver for insurance purposes. The data base may include a list of drivers or vehicles that correspond to a high risk driver based on the driver having a threshold number of tickets, the driver having been arrested for drunk driving, the driver having filed a threshold number of claims within a specific time period, or other indication of risk. For example, individuals who have been arrested for drunk driving or who have received a large number of tickets may be more likely, from a risk and statistical perspective, to have more expensive or a larger number of claims. Insurers may determine other attributes or events that may indicate high risk levels.

In one embodiment, the driving monitoring component 102 may modify operation based on whether or not the high risk driver component 220 determines that a driver is a high risk driver. For example, if the individual is not a high risk driver the risk data component 204 may not determine risk data and the routing component 210 may not provide driving and/or risk data to an insurer. According to one embodiment, data corresponding to individuals who are not determined to be high risk drivers is deleted or is not further processed. Removal or discarding of data not corresponding to high risk drivers may help reduce privacy concerns and/or provide an incentive for drivers to drive safely.

The billing component 222 determines a compensation amount to be paid for access to sensor data, driving data, and/or risk data. According to one embodiment, the billing component 222 determines a billing amount for access to driving data or risk data provided by the driving monitoring component 102. For example, insurers or other insurance entities may be required to pay a subscription fee for a subscription period, a per access fee, or a fee on another basis for the sensor data, driving data, and/or risk data obtained and generated by the driving monitoring component 102. In one embodiment, the billing amount is based on a quantity of driving data or the number of events detected.

According to one embodiment, the billing component 222 determines a compensation amount that is owed to an operator or owner of a portable electronic device 114. For example, if a portable electronic device 114 is used to report a driving event the billing component 222 may determine a compensation amount or bounty for the operator or owner of the portable electronic device 114. The compensation amount may encourage individuals to report bad driving behavior.

According to one embodiment, the billing component 222 may determine varying compensation amounts based on a variety of factors. For example, a compensation amount may vary based on a type of driving event, a time of occurrence of the driving event, a traffic condition during the driving event, a weather condition during the driving event, a quality of sensor data, a type of sensor data, or the like. For example, more dangerous events or conditions of a driving event may increase the compensation amount to the user who reports the driving event. As another example, video data may have a greater corresponding compensation amount than still images. Furthermore, sensor data corresponding to a high risk driver may be worth more than sensor data corresponding to low risk drivers or drivers that are not high risk drivers.

The billing component 222 may also determine the compensation amount based on how many reports of a driving event have been received. For example, if multiple people report the same driving event, the compensation amount may be decreased. Additionally, the number of reports received from a single individual or portable electronic device 114 may also affect a compensation amount. A greater or reduced compensation amount may be paid as more and more reports are received from the same portable electronic device 114.

As discussed above, the driving monitoring component 102 may perform a variety of functions and services related to driving monitoring and/or updating insurance properties. According to one embodiment, the driving monitoring component 102 may be configured to periodically process sensor and/or driving data. For example, the driving monitoring component 102 may receive driving data and sensor data during a data gathering period and then process the data as a block at the end of the gathering period. The periodic processing of data may provide updated risk data and/or insurance properties on update intervals that may be minutes, hours, days, weeks, months, or even years. In one embodiment, driving data and sensor data from a previous month are processed to assign an updated insurance property at the end of each month.

According to one embodiment, the driving monitoring component 102 is configured to provide risk data and/or an updated insurance property within a real-time threshold of receiving the driving data and/or sensor data. For example, the driving monitoring component 102 may update risk data and/or insurance data within a real-time threshold of receiving sensor data or information regarding a driving event.

In one embodiment, an update interval or real-time threshold may vary between drivers and/or vehicles. For example, high risk drivers may have shorter risk data update intervals to allow for more granular adjustment of risk. Similarly, longer update intervals may be sufficient for low risk drivers or drivers who have excellent driving histories.

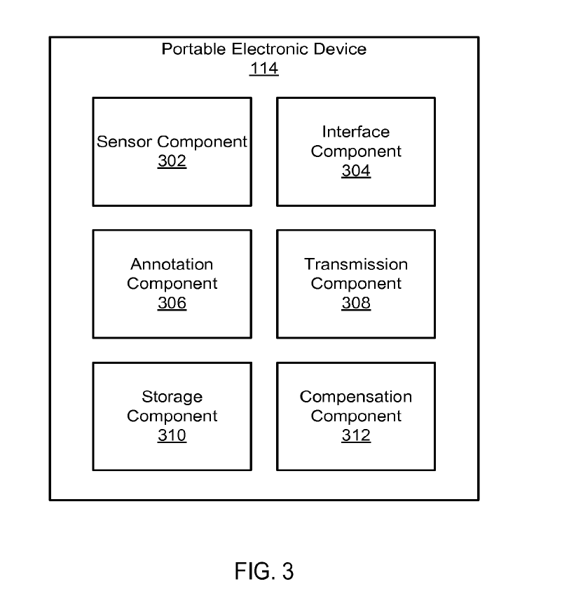

Turning now to FIG. 3, a schematic block diagram illustrating example components of a portable electronic device 114 for reporting a driving event is shown. The portable electronic device 114 includes a sensor component 302, an interface component 304, an annotation component 306, a transmission component 308, a storage component 310, and a compensation component 312. As will be understood by one of skill in the art, the components 302-312 are given by way of example only. Some embodiments may include fewer, additional, or any combination of the illustrated components. One or more components 202-222 of the driving monitoring component 102 may also be included in the portable electronic device 114, in some embodiments.

The portable electronic device 114 may include any type of computing or communication device. In one embodiment, the portable electronic device 114 includes a phone such as a smart phone. For example, a smart phone may store and/or execute code that implements the functions of the components 302-312. One or more of the components 302-312 may be embodied in a phone app, or the like. Similarly, the portable electronic device 114 may include a tablet computer, notebook computer, personal digital assistant (PDA), or any other portable computing device. In one embodiment, the portable electronic device 114 may include a system on board a vehicle. For example, the portable electronic device 114 may include a camera such as a dash camera, rear view camera, navigation system, or other sensor system on or in the vehicle. An on-board camera of one vehicle may be used to obtain visual data surrounding the vehicle, such as of other vehicles and drivers, which can be used to report a driving event.

The sensor component 302 may obtain data from one or more sensors of the portable electronic device 114 or other sensor in communication with the portable electronic device 114. The sensor component 302 may obtain data from one or more cameras, such as images, video, or other visual data of another vehicle or driver. The sensor component 302 may obtain location data such as GPS coordinates from a GPS unit, location data based on a connection with a communications tower, or other location data. The sensor component 302 may obtain audio from a microphone. The sensor component 302 may obtain direction, acceleration, or other data for the portable electronic device 114 from an accelerometer, electronic compass, or any other sensor. According to one embodiment, the sensor component 302 obtains sensor data about surrounding vehicles or objects which may correspond to a driving event.

The interface component 304 receives input from a user. In one embodiment, the interface component 304 provides an interface for a user to interact with the portable electronic device 114. For example, the interface component 304 may provide a visual interface on a display screen, an audio interface using a microphone and/or speaker, or any other interface for interacting with a user. In one embodiment, the interface component 304 provides an option to report sensor data. For example, a user may be able to gather sensor data using the portable electronic device 114 and then initiate reporting of the sensor data by selecting the option to report. The interface component 304 may also provide an interface that provides sensor data for the user to observe.

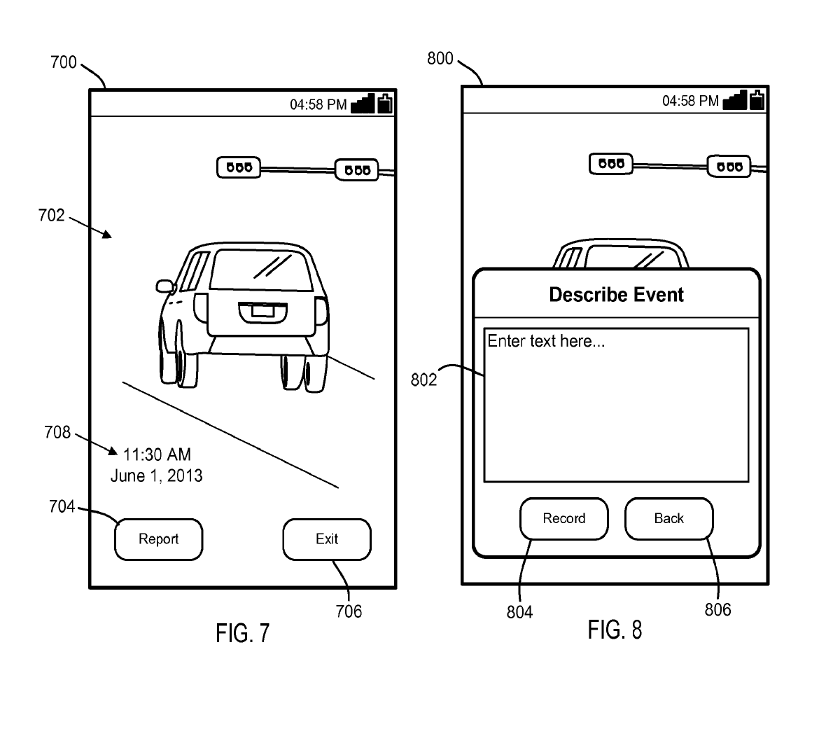

FIG. 7 illustrates an example screenshot of a visual interface 700 which may be provided by the interface component 304. The visual interface 700 illustrates an image 702 captured by the sensor component 302. A user may be able to view the image 702 to determine if sufficient data for reporting of a driving event has been obtained. An evaluation algorithm (running on the portable electronic device or in the cloud) may automatically determine whether sufficient data has been obtained and can inform the user. The evaluation algorithm may identify and suggest additional data or annotations which would enhance the compensation or quality of the report. Other sensor data may be displayed, such as a time, a position, a speed, or other data. In one embodiment, the user may be able to watch a recorded video or other data to select portions that illustrate the occurrence of a driving event. The visual interface 700 includes a report option 704 and an exit option 706. A user may be able to select the report option 704 when the user wants to report an event. According to one embodiment, a user may select the report option 704 by touching a touch screen. In another embodiment, a user may be able to use a button, keyboard, or other input device to select a report option. In one embodiment, a microphone may be used to detect a voice command spoken by the user. Alternatively, the user may be able to select the exit option 706 to halt display of sensor data and/or stop the gathering of sensor data.

The interface component 304 may also provide an interface that allows a user to provide a description of a driving event. For example, the user may be able to enter text describing an event, record audio of the user describing the event, or the like. FIG. 8 illustrates an example screenshot of a visual interface 800 which may be provided by the interface component 304 to allow a user to enter a description of a driving event. The visual interface 800 may be displayed in response to a user selecting the report option 704 of FIG. 7. The visual interface 800 includes a text field 802 where a user can enter a text description of an event. The visual interface 800 also includes a record option 804 that may be selected to record a verbal description of the event. A back option 806 is provided for a user to return to a sensor data gathering interface, such as the interface 700 of FIG. 7.

In one embodiment, the interface component 304 may provide a set of options which may be selected by the user to report the occurrence of an event. For example, a drop down menu may include description options that indicate a driving event involved speeding, an accident, rude behavior, or other driving event. Thus, a user may not be required to actually type text or other details. In one embodiment, an audio interface may allow a user to initiate reporting, provide a description, and or select from available options using voice commands. An audio interface may allow a driver to report a driving event without having to manipulate a device with the driver's hands and/or look away from the road.

The annotation component 306 annotates a portion of the sensor data. The annotation component 306 may annotate a portion of the sensor data that will be included in a report to include additional information about a driving event. For example, the annotation component 306 may add metadata to a file including the sensor data or may associate data with the sensor data. In another embodiment, the annotation component 306 may annotate the sensor data by adding a time stamp. For example, a visual time stamp may be added to visual information or an audio time stamp may be added to audio information. FIG. 7 illustrates an example time stamp 708 that has been added to an image.

The annotation component 306 may annotate the sensor data to include time information regarding when the sensor data was obtained. For example, the time information may indicate a time and/or a date when the sensor data was obtained. The annotation component 306 may annotate the sensor data to include location information to indicate a location of the portable electronic device 114 and/or the location of a driving event. For example, the location information may include GPS information, map coordinates, a street name, location information corresponding to a communication tower, or other location information.

The annotation component 306 may also annotate the sensor data with a description of a driving event. For example, a user may able to enter a description of the event or the portable electronic device 114 may be able to create a description of the event to be included in the report. For example, a description entered using the visual interface 800 of FIG. 8 may be stored with the sensor data. The sensor data may also include location data, speed data, or other data for a vehicle involved in an event. For example, the annotation component 306 may include orientation information metadata indicating an orientation of the sensor with the portion of the sensor data. As another example, the annotation component 306 may annotate the portion of the sensor data by including velocity information metadata and/or identification information metadata with the portion of the sensor data.

The transmission component 308 sends the annotated portion of the sensor data to an insurance risk entity. The transmission component 308 may transmit a report that includes the sensor data, the annotation data, and/or other data to an insurance risk entity such as the insurer system 108, driving monitoring component 102, or other device or system. In one embodiment, the transmission component 308 includes a wireless transmitter for transmitting information over a mobile network. Thus, the portable electronic device 114 may be able to quickly report driving events involving other vehicles. In one embodiment, the transmission component 308 sends the annotated portion to a third-party system or device which then forwards the data to a corresponding insurance provider or other entity.

In one embodiment, the transmission component 308 may also send the data to a legal authority. For example, if a user indicates that a law may have been broken or has entered a description of an event that may violate the law, the transmission component 308 may send the annotated portion of the sensor data to a legal authority as well.

The storage component 310 stores sensor data, annotation data, or other data in memory. The memory may include dynamic or static memory. In one embodiment, the storage component 310 is configured to operate as a circular buffer where sensor data is stored. Because a user or portable electronic device 114 may not determine that an event should be reported until the event has occurred, the storage component 310 may store all sensor data for a specific length of time. For example, a circular buffer may be configured to continuously acquire and store the most recent five minutes worth of sensor data. When the circular buffer is full, the storage component 310 then writes over the oldest data so that the most recent five minutes of data are available in memory. A user may thus be able to wait until after an event has occurred before deciding to report rather than attempting to predict that an event will occur. For example, a camera mounted on a dash of a vehicle may be able to acquire footage of surrounding vehicles. When a driving event occurs, the driver or a passenger can initiate reporting of the event.

The compensation component 312 determines an anticipated compensation amount. The compensation component 312 may determine an anticipated compensation amount to be paid for a report. For example, the compensation component 312 may determine the anticipated compensation amount after a user has selected a report command to report a driving event. The compensation component 312 may determine an amount based on at least one of the driving event, a quality of the sensor data, a type sensor data to be reported, a location of the driving event, a time of day, and/or a description provided by the user. In one embodiment, the compensation component 312 may calculate an anticipated compensation amount in a similar manner as the billing component 222 of the driving monitoring component 102.

The compensation component 310 may display, play audio, or otherwise present the anticipated compensation amount to the user. The user may be able to then decide whether the user wants to report the driving event. In one embodiment, the compensation component 310 presents the anticipated compensation amount after the sensor data has been annotated and is ready to be sent so that a more accurate understanding of the potential compensation value can be determined.

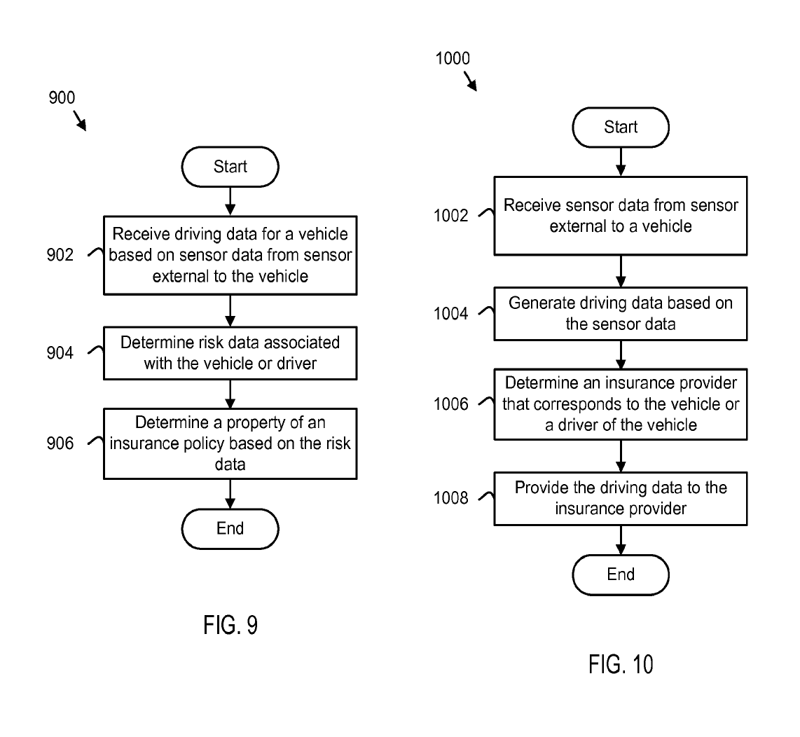

FIG. 9 is a schematic flow chart diagram illustrating one embodiment of a method 900 for determining a property of an insurance policy. In one embodiment, the method 900 is performed by the driving monitoring component 102.

The method 900 begins and the receiving component 202 receives 902 driving data for a vehicle. The driving data may include driving data based on sensor data from a sensor that is external to the vehicle. For example, the receiving component 202 may receive 902 the sensor data from a traffic monitoring system 104 and/or a portable electronic device 114. The sensor data may include visual data, location data, identification data, and/or other data that provides evidence of the occurrence of a driving event. In one embodiment, the driving data includes a description of a driving event in which the vehicle was involved.

The risk data component 204 determines 904 risk data associated with the vehicle or a driver of the vehicle. For example, the risk data component 204 may determine a risk score based on the driving data received 902 by the receiving component 202. Similarly, the risk data component 204 may determine 904 a risk score based on a driving log for the driver or vehicle.

The insurance property component 212 determines 906 an insurance property of an insurance policy based on the risk data. In one embodiment, the insurance property component 212 determines 906 an insurance property that reduces risk to an insurance provider in response to risk data that indicates a greater risk in insuring an individual or vehicle. For example, an insurance premium may be increased, a coverage scope may be reduced, or the like. Similarly, the insurance property component 212 may determine 906 an insurance property that increases risk to an insurance provider in response to risk data that indicates a low risk in insuring an individual or vehicle.

FIG. 10 is a schematic flow chart diagram illustrating one embodiment of a method 1000 for obtaining driving data for an insurance provider. In one embodiment, the method 1000 is performed by the driving monitoring component 102.

The method 1000 begins and the receiving component 202 receives 1002 sensor data from one or more sensors external to a vehicle. The sensor data may include data from cameras, location devices, identification tag readers, temperature sensors, radar units, or any other sensor. For example, the receiving component 202 may receive 1002 the sensor data from a sensor of a traffic monitoring system 104 and/or a sensor of a portable electronic device 114. The sensor data may include visual data, location data, identification data, and/or other data that provides evidence of the occurrence of a driving event that involves the vehicle.

The driving data component 214 generates 1004 driving data based on the sensor data. In one embodiment, the driving data component 214, event component 216, and/or driving route component 218 generate 1004 driving data that indicates the occurrence of a driving event or the existence of a weather or traffic condition. The driving data component 214 may generate 1004 the driving data by processing sensor data to determine events or conditions that may affect a risk of insuring the vehicle or a driver of the vehicle.

The identification component 208 determines 1006 an insurance provider that corresponds to the vehicle or a driver of the vehicle. For example, the identification component 208 may identify the driver and/or the vehicle and then locate a corresponding insurance provider. In one embodiment, the identification component 208 determines 1006 the insurance provider by looking up the driver or vehicle in a database to locate the corresponding insurance provider and/or a corresponding insurance policy.

The routing component 210 provides 1008 the driving data and/or sensor data to the insurance provider determined 1006 by the identification component 208. In one embodiment, the routing component 210 provides 1008 the driving data and/or sensor data by providing a message that includes at least some of the driving data. In one embodiment, the routing component 210 provides 1008 the driving data and/or sensor data by providing a message notifying the insurance provider of the availability of the driving data. For example, the routing component 210 may store the driving data in a location accessible by the insurance provider. The insurance provider may then access and/or process the driving data to determine an insurance property for the driver or vehicle.

FIG. 11 is a schematic flow chart diagram illustrating one embodiment of a method 1100 for updating a property of an insurance policy. In one embodiment, the method 1100 is performed by the driving monitoring component 102.

The method 1100 begins and the receiving component 202 receives 1102 sensor data from a portable electronic device 114. The sensor data includes data regarding a vehicle involved in a driving event. In one embodiment, the sensor data includes visual data captured by a camera of the portable electronic device 114. In one embodiment, the receiving component 202 receives 1102 sensor data annotated with additional data regarding a driving event. For example, the sensor data may be annotated with a time, location, event description, or the like that may be useful in understanding what occurred at a driving event.

The identification component 208 identifies 1104 the driver and/or the vehicle based on the sensor data. In one embodiment, the identification component 208 identifies 1104 the driver based on facial recognition and/or another physical feature of the driver. In one embodiment, the identification component 208 identifies 1104 the vehicle based on a license plate, an identification tag, and/or on physical features of the vehicle. The identification component 208 may identify 1104 the driver and/or vehicle based on visual data, audio data, information gathered by a identification tag reader, or the like.

The risk data component 204 determines 1106 risk data associated with the vehicle or a driver of the vehicle. For example, the risk data component 204 may determine 1106 a risk score based on the sensor data and/or driving data received 1102 by the receiving component 202. Similarly, the risk data component 204 may determine a risk score based on a driving log for the driver or vehicle.

The insurance property component 212 updates 1108 an insurance property of an insurance policy based on the risk data. In one embodiment, the insurance property component 212 updates 1108 an insurance property to reduce risk to an insurance provider in response to risk data that indicates a greater risk in insuring an individual or vehicle. For example, an insurance premium may be increased, a coverage scope may be reduced, or the like. Similarly, the insurance property component 212 may update 1108 an insurance property that increases risk to an insurance provider in response to risk data that indicates a low risk in insuring an individual or vehicle.

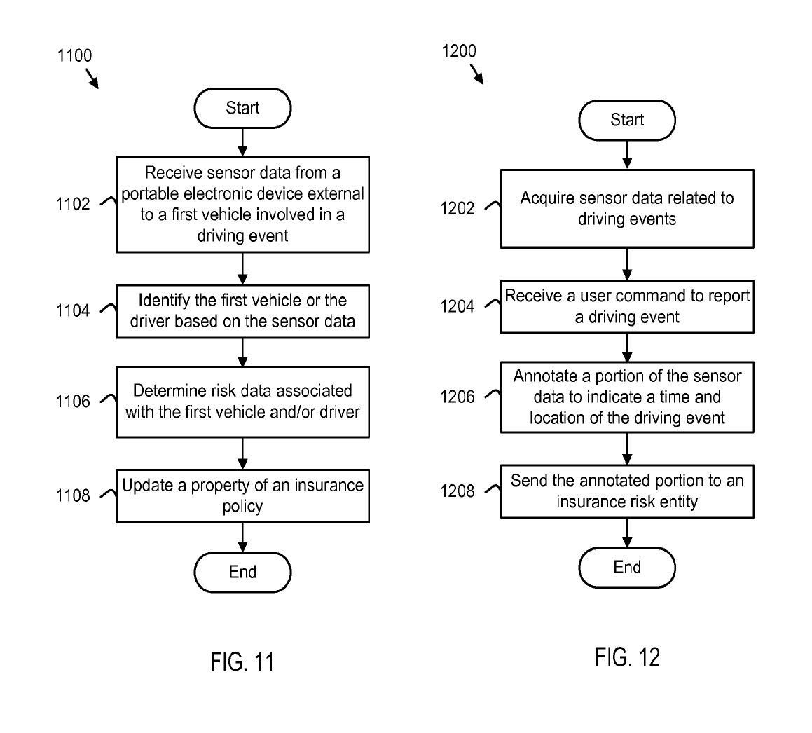

FIG. 12 is a schematic flow chart diagram illustrating one embodiment of a method 1200 for reporting a driving event. In one embodiment, the method 1200 is performed by the portable electronic device 114.

The method 1200 begins and the sensor component 302 acquires 1202 sensor data related to one or more driving events. The sensor component 302 may acquire 1202 the sensor data by capturing an image, capturing video, obtaining acceleration data, and/or acquiring other types of sensor data. In one embodiment, the sensor component 302 acquires 1202 sensor data continuously.

The interface component 304 receives 1204 a user command to report a driving event. The command may include an audio command and/or input via a button, keyboard, or touch screen. In one embodiment, the interface component 304 provides a report command on a touch screen and receives 1204 the user command in response to selecting the report command.

The annotation component 306 annotates 1206 the sensor data acquired 1202 by the sensor component 302 with additional information. The additional information may include a time, a location, and/or a description of a driving event. In one embodiment, the annotation component 306 annotates 1206 the sensor data with additional sensor data, such as sensor data that indicates a location and/or orientation of the portable electronic device 114.

The transmission component 308 sends 1208 the annotated portion to an insurance risk entity. The transmission component 308 may send 11208 the annotated portion wirelessly via a mobile network. In one embodiment, the transmission component 308 sends 1208 the annotated portion to a risk entity that includes a driving monitoring component 102. For example, the transmission component 208 may send 1208 the annotated portion from the portable electronic device 114, via a network 112, to a driving monitoring component 102. Similarly, the transmission component 308 may send 1208 the annotated portion to the insurer system 108. The insurer system 108 or the driving monitoring component 102 may then determine or update an insurance property for a policy that corresponds to the vehicle or driver.

This disclosure has been made with reference to various example embodiments including the best mode. However, those skilled in the art will recognize that changes and modifications may be made to the embodiments without departing from the scope of the present disclosure. For example, various operational steps, as well as components for carrying out operational steps, may be implemented in alternate ways depending upon the particular application or in consideration of any number of cost functions associated with the operation of the system, e.g., one or more of the steps may be deleted, modified, or combined with other steps.

Additionally, as will be appreciated by one of ordinary skill in the art, principles of the present disclosure may be reflected in a computer program product on a computer-readable storage medium having computer-readable program code means embodied in the storage medium. Any tangible, non-transitory computer-readable storage medium may be utilized, including magnetic storage devices (hard disks, floppy disks, and the like), optical storage devices (CD-ROMs, DVDs, Blu-Ray discs, and the like), flash memory, and/or the like. These computer program instructions may be loaded onto a general purpose computer, special purpose computer, or other programmable data processing apparatus to produce a machine, such that the instructions that execute on the computer or other programmable data processing apparatus create a means for implementing the functions specified. These computer program instructions may also be stored in a computer-readable memory that can direct a computer or other programmable data processing apparatus to function in a particular manner, such that the instructions stored in the computer-readable memory produce an article of manufacture, including implementing means that implement the function specified. The computer program instructions may also be loaded onto a computer or other programmable data processing apparatus to cause a series of operational steps to be performed on the computer or other programmable apparatus to produce a computer-implemented process, such that the instructions that execute on the computer or other programmable apparatus provide steps for implementing the functions specified.

While the principles of this disclosure have been shown in various embodiments, many modifications of structure, arrangements, proportions, elements, materials, and components, which are particularly adapted for a specific environment and operating requirements, may be used without departing from the principles and scope of this disclosure. These and other changes or modifications are intended to be included within the scope of the present disclosure.

The foregoing specification has been described with reference to various embodiments. However, one of ordinary skill in the art will appreciate that various modifications and changes can be made without departing from the scope of the present disclosure. Accordingly, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, a required, or an essential feature or element. As used herein, the terms “comprises,” “comprising,” and any other variation thereof, are intended to cover a non-exclusive inclusion, such that a process, a method, an article, or an apparatus that comprises a list of elements does not include only those elements but may include other elements not expressly listed or inherent to such process, method, system, article, or apparatus. Also, as used herein, the terms “coupled,” “coupling,” and any other variation thereof are intended to cover a physical connection, an electrical connection, a magnetic connection, an optical connection, a communicative connection, a functional connection, and/or any other connection.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A vehicle monitoring system with cooperative internal and external sensors, the system comprising:
a first internal sensor system, positioned at least partially within a vehicle, configured to identify a non-driving action performed by an operator of the vehicle,
wherein the first internal sensor system comprises at least one of an acoustic sensor, an ultrasonic sensor, and an image sensor;
a second vehicle sensor system associated with the vehicle that is configured to identify the occurrence of a driving event involving the vehicle operated by the operator,
wherein the second vehicle sensor system comprises at least one of: an image sensor, an acoustic sensor, an electromagnetic sensor, an impact sensor, a moisture sensor, an accelerometer, an motion sensor, a velocity sensor, and an ultrasonic sensor;
a third external sensor system physically separated from the vehicle and controlled by an entity other than the operator configured to transmit a report regarding the occurrence of the driving event involving the vehicle operated by the operator;
a processing apparatus of the vehicle monitoring system configured to:
receive the report transmitted by the third external sensor system,
confirm the occurrence of the driving event based on data received from the second vehicle sensor system,
associate the non-driving action performed by the operator with the driving event, and
report the non-driving action performed by the operator to a third party.

2. The vehicle monitoring system of claim 1, wherein the second vehicle sensor system is configured to identify a driving event comprising at least one of: a lane change, exceeding a speed limit, violating a traffic signal, passing through a cross-walk occupied by a pedestrian, accelerating at an excessive rate, impact with an object, and following another vehicle too closely.

3. The vehicle monitoring system of claim 1, wherein the first internal sensor system is configured to identify a non-driving action comprising at least one of: eating food while driving, using a phone while driving, and drinking a drink while driving.

4. The vehicle monitoring system of claim 1, further comprising an identification component configured to identify at least one of an owner and an operator of the vehicle.

5. The vehicle monitoring system of claim 1, wherein the third external sensor comprises a portable electronic device.

6. The vehicle monitoring system of claim 1, wherein the first internal sensor system comprises a camera, wherein the second vehicle sensor system comprises a camera, and wherein the third, external sensor system comprises a camera.

7. The vehicle monitoring system of claim 1, wherein the first internal sensor system comprises a sensor internal to the vehicle in communication with a processing apparatus that is external to and physically disconnected from the vehicle.

8. The vehicle monitoring system of claim 1, wherein the second vehicle sensor system comprises a sensor physically connected to the vehicle in communication with a processing apparatus that is external to and physically disconnected from the vehicle.

9. The vehicle monitoring system of claim 1, wherein the processing apparatus of the vehicle monitoring system is external to and physically disconnected from the vehicle and controlled by the third party.

10. The vehicle monitoring system of claim 9, wherein the processing apparatus of the vehicle monitoring system is in communication with each of the first internal sensor system and the second vehicle sensor system.

11. The vehicle monitoring system of claim 1, wherein the processing apparatus of the vehicle monitoring system is located within the vehicle.

12. The vehicle monitoring system of claim 1, wherein the third external sensor system is configured to transmit a report that comprises at least one of a description of the driving event, a photo of the driving event, and a video of the driving event.

13. A method for monitoring a vehicle with cooperative internal and external sensors, the method comprising:
recording on a digital recording medium, via a first internal sensor system positioned at least partially within a vehicle, a non-driving action performed by an operator of the vehicle, wherein the first internal sensor system comprises at least one of identifying an acoustic sensor, an ultrasonic sensor, and an image sensor;
identifying the occurrence of a driving event involving the vehicle operated by the operator, via a second vehicle sensor system;
receiving a transmission of a report of an occurrence of the driving event involving the vehicle operated by the operator via a third external sensor system physically separated from the vehicle and controlled by an entity other than the operator;
associating, via a processing apparatus, the non-driving action performed by the operator with the driving event identified by the second vehicle sensor system and reported by the third external sensor system, and
reporting the non-driving action performed by the operator to a third party.

14. The method of claim 13, wherein identifying the occurrence of the driving event via the second vehicle sensor system comprises identifying a driving event that includes at least one of: a lane change, exceeding a speed limit, violating a traffic signal, passing through a cross-walk occupied by a pedestrian, accelerating at an excessive rate, impact with an object, and following another vehicle too closely.

15. The method of claim 13, wherein recording the non-driving action via the first internal sensor system comprises recording the operator of the vehicle performing a non-driving action that includes at least one of: eating food while driving, using a phone while driving, and drinking a drink while driving.

16. The method of claim 13, further comprising identifying at least one of an owner and an operator of the vehicle.

17. The method of claim 13, wherein the third external sensor comprises a portable electronic device.

18. The method of claim 13, wherein the first internal sensor system comprises a camera, wherein the second vehicle sensor system comprises a camera, and wherein the third, external sensor system comprises a camera.

19. The method of claim 13, wherein the first internal sensor system comprises a sensor internal to the vehicle in communication with a processing apparatus that is external to and physically disconnected from the vehicle.

20. The method of claim 13, wherein the second vehicle sensor system comprises a sensor physically connected to the vehicle in communication with a processing apparatus that is external to and physically disconnected from the vehicle.

21. The method of claim 13, wherein the processing apparatus of the vehicle monitoring system is external to and physically disconnected from the vehicle and controlled by the third party.

22. The method of claim 21, wherein the processing apparatus of the vehicle monitoring system is in communication with each of the first internal sensor system and the second vehicle sensor system.

23. The method of claim 13, wherein the processing apparatus of the vehicle monitoring system is located within the vehicle.

24. The method of claim 13, wherein the processing apparatus of the vehicle monitoring system is in communication with each of the first internal sensor system and the second vehicle sensor system.

25. The method of claim 13, wherein the processing apparatus of the vehicle monitoring system is located within the vehicle.

26. The method of claim 13, further comprising logging one or more of a roadway condition, a driving route, and a traffic condition associated with the driving event.

27. The method of claim 13, further comprising determining a location of the vehicle in relation to one or more objects or vehicles based on two or more instances of visual data obtained at different locations by the third external sensor system and a fourth external sensor system.

28. The method of claim 13, wherein the report of the occurrence of the driving event comprises at least one of: a description of the driving event, a photo of the driving event, and a video of the driving event.

29. A vehicle monitoring system with cooperative internal and external sensors, the system comprising:
a first sensor system, positioned at least partially within a vehicle, configured to identify a non-driving action performed by an operator of the vehicle;
a second sensor system associated with the vehicle that is configured to identify the occurrence of a driving event involving the vehicle operated by the operator;
a third sensor system physically separated from the vehicle and controlled by a first independent entity configured to transmit a first report regarding the occurrence of the driving event involving the vehicle operated by the operator;
a fourth sensor system physically separated from the vehicle and controlled by a second independent entity configured to transmit a second report regarding the occurrence of the driving event involving the vehicle operated by the operator; and
a processing apparatus of the vehicle monitoring system configured to:
confirm the occurrence of the driving event based on data received from the second sensor system,
determine a location of the vehicle in relation to one or more objects or other vehicles based on the first report from the third sensor system and the second report from the fourth sensor system;
associate the non-driving action performed by the operator with the driving event, and
report the non-driving action performed by the operator.

30. The vehicle monitoring system of claim 29, wherein the second sensor system is configured to identify a driving event comprising at least one of: a lane change, exceeding a speed limit, violating a traffic signal, passing through a cross-walk occupied by a pedestrian, accelerating at an excessive rate, impact with an object, and following another vehicle too closely.

31. The vehicle monitoring system of claim 29, wherein the first sensor system is configured to identify a non-driving action comprising at least one of: eating food while driving, using a phone while driving, and drinking a drink while driving.

32. The vehicle monitoring system of claim 29, wherein the second sensor system comprises at least one of: an image sensor, an acoustic sensor, an electromagnetic sensor, an impact sensor, a moisture sensor, an accelerometer, an motion sensor, a velocity sensor, and an ultrasonic sensor.

33. The vehicle monitoring system of claim 29, wherein at least one of the third sensor and the fourth sensor comprises a portable electronic device.

34. The vehicle monitoring system of claim 29, wherein the first sensor system comprises at least one of: an acoustic sensor, an ultrasonic sensor, and an image sensor.

35. The vehicle monitoring system of claim 29, wherein the third sensor system is configured to transmit a report that comprises at least one of a description of the driving event, a photo of the driving event, and a video of the driving event.

36. The vehicle monitoring system of claim 29, wherein the fourth sensor system is configured to transmit a report that comprises at least one of a description of the driving event, a photo of the driving event, and a video of the driving event.
